(19) United States
(12) Patent Application Publication
(10) Pub. No.: US 2021/0176973 A1
(43) Pub. Date: Jun. 17, 2021

(54) TWO-EYED FISH HOOK

(71) Applicant: Jack Barr, Carbondale, KS (US)

(72) Inventor: Jack Barr, Carbondale, KS (US)

(21) Appl. No.: 16/716,303

(22) Filed: Dec. 16, 2019

(51) Int. Cl. A01K 91/04; A01K 83/04

(52) U.S. Cl. CPC A01K 91/04; A01K 83/04

(57) ABSTRACT

An illustrated view of an exemplary fish hook device for keeping the fish hook in a desired position is presented. The exemplary fish hook device is useful for keeping a hook straight allowing for fish line to pull straight through water to snag fish. Further, the fishing line will be easier and faster as well as using less fishing line when coupling the hook 101 on the fishing line. The fish hook device has a hook, a first eyelet and a second eyelet. The hook has a first prong hook, a second hook and a third fishing hook. A fish line is configured to be threaded through the first eyelet and directly run to the second eyelet where it is threaded. The fish line does not need to be wrapped around the hook to allow the for the fish line to pull straight through water to snag fish. An optionally weight may be coupled to an end of the fish line.

### FIELD OF THE INVENTION

This invention relates to fish hooks. More particularly, it relates to eyelets for fish hooks.

### BACKGROUND

A fish hook or fishhook is a device for catching fish either by impaling them in the mouth or, more rarely, by snagging the body of the fish. Fish hooks have been employed for centuries by anglers to catch fresh and saltwater fish. Fish hooks are normally attached to some form of line or lure which connects the caught fish to the angler.

There is an enormous variety of fish hooks in the world of fishing. Sizes, designs, shapes, and materials are all variable depending on the intended purpose of the fish hook. Fish hooks are manufactured for a range of purposes from general fishing to extremely limited and specialized applications. Fish hooks are designed to hold various types of artificial, processed, dead or live baits (bait fishing); to act as the foundation for artificial representations of fish prey (fly fishing); or to be attached to or integrated into other devices that represent fish prey (lure fishing).

There are a large number of different types of fish hooks. At the macro level, there are bait hooks, fly hooks and lure hooks. Within these broad categories there are wide varieties of hook types designed for different applications. Hook types differ in shape, materials, points and barbs, and eye type, and ultimately in their intended application.

When individual hook types are designed the specific characteristics of each of these hook components are optimized relative to the hook's intended purpose. For example, a delicate dry fly hook is made of thin wire with a tapered eye because weight is the overriding factor. Whereas Carlisle or Aberdeen light wire bait hooks make use of thin wire to reduce injury to live bait but the eyes are not tapered because weight is not an issue. Many factors contribute to hook design, including corrosion resistance, weight, strength, hooking efficiency, and whether the hook is being used for specific types of bait, on different types of lures or for different styles of flies. For each hook type, there are ranges of acceptable sizes. For all types of hooks, sizes range from 32 (the smallest) to 20/0 (the largest).

Hooks are designed as either single hooks—a single eye, shank and point; double hooks—a single eye merged with two shanks and points; or triple—a single eye merged with three shanks and three evenly spaced points. Double hooks are formed from a single piece of wire and may or may not have their shanks brazed together for strength. Treble hooks are formed by adding a single eyeless hook to a double hook and brazing all three shanks together. Double hooks are used on some artificial lures and are a traditional fly hook for Atlantic Salmon flies, but are otherwise fairly uncommon. Treble hooks are used on all sorts of artificial lures as well as for a wide variety of bait applications.

The eye of a hook, although some hooks are technically eyeless, is the point where the hook is connected to the line. Hook eye design is usually optimized for either strength, weight and/or presentation. There are different types of eyes to the hooks. Typical eye types include the ring or ball eye, a brazed eye—the eye is fully closed, a tapered eye to reduce weight, a looped eye—traditional on Atlantic Salmon flies, needle eyes, and spade end—no eye at all, but a flattened area to allow secure Snelling of the leader to the hook. Hook eyes can also be positioned one of three ways on the shank—up turned, down turned or straight.

When there is only one eye or eyeless hooks, the line is attached but the hook is often offset or skewed from being straight. This could result in the line being tangled in the hook, the hook being more easily tangled in weeds or other items in the water or can be difficult to detect a fish being on the hook.

In light of the foregoing, it would be desirable to devise an improved fish hook device that provides more than one eye such that the problems described above are hereby addressed as well as other problems not described such as reducing the amount of line being used to keep the hook in a proper straight condition.

### BRIEF DESCRIPTION OF THE DRAWINGS

FIG. 1 is an illustrated view of an exemplary fish hook device.

FIG. 2 is an illustrated view of multiple coupled exemplary fish hook devices shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

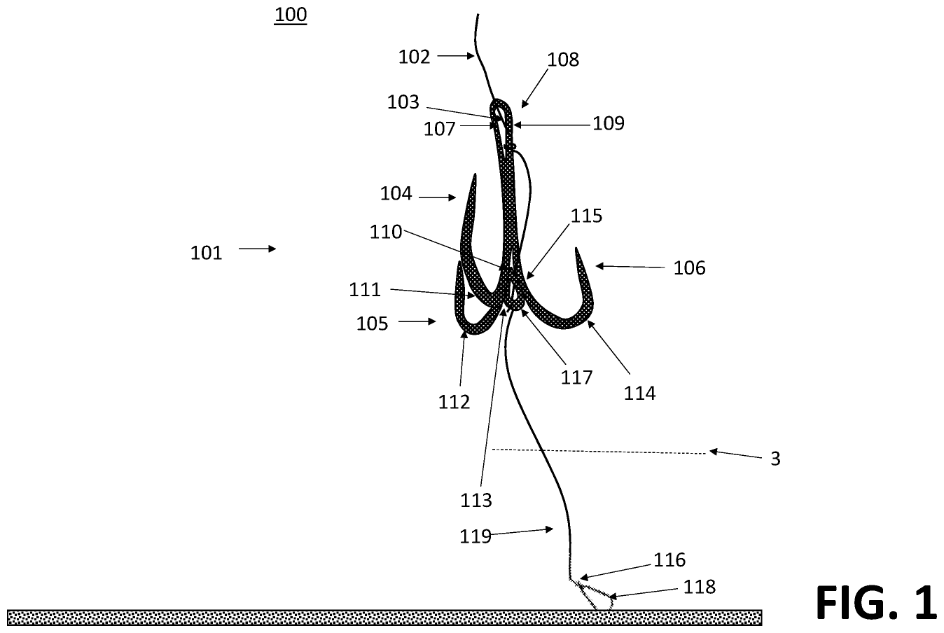

Referring to FIG. 1, an illustrated view of an exemplary fish hook device 100 for keeping the fish hook in a desired position is presented. The exemplary fish hook device 100 is useful for keeping a hook 101 straight allowing for fish line 102 to pull straight through water to snag fish. Further, the fishing line will be easier and faster as well as using less fishing line when coupling the hook 101 on the fishing line 102.

The fish hook device 100 has a hook 101, a first eyelet 103 and a second eyelet 117. The hook 101 has a first prong hook 104, a second hook 105 and a third fishing hook 105. The hook 101 is preferably a treble prong hook, but other types of hooks are hereby contemplated, including, but not limited to, a double prong hook, a single prong hook, etc. The hook 101 is preferably made of a metal material such as steel, but other materials are hereby contemplated, including, but not limited to, aluminum, poly-vinyl chloride (PVC), etc.

A top 107 of the first prong hook 104, to a top 108 of the second prong hook 105 and to a top 109 of the third prong hook 106 are coupled to form the first eyelet 103. The hook 101 is preferably a single piece, but may each of the first prong hook 104, the second prong hook 105 and the third prong hook 106 may be separate.

The fish line 102 is removably coupled to a reel (not shown). The fish line 102 is configured to be threaded through the first eyelet 103 of the fish hook device 100.

Currently, the fish line 102 is wrapped making multiple loops around the first prong 104, the second prong 105 and the third prong 106 to allow the hook 100 allowing for fish line 102 to pull straight through water to snag fish.

The second eyelet 117 is coupled to a top portion 110 of a bent portion 111 of the first prong hook 104. The second eyelet 117 is further coupled to a top portion 112 of a bent portion 113 of the second prong hook 105 and is also coupled to a top portion 114 of a bent portion 115 of the third prong hook 106.

The fish line 101 is coupled through the first eyelet 102. The fish line 101 is coupled to the second eyelet 117 and is threaded through the second eyelet 117 where it may be tied. Optionally and/or additionally, an end 116 of the second fish line 119 is coupled to a weight 118. The second fish line 119 is lighter fish line than the fish line 101, thus if the weight 118 is snagged and causes the line to break at second breaking point 1, the second fish line 119 will break and the weight 118 will be lost but the hook 100 will not be broken from the fish line 101. In current fishing devices, the breaking point 3 will be the normal break of the fish line 101 and the entire fish hook device 100 would be lost.

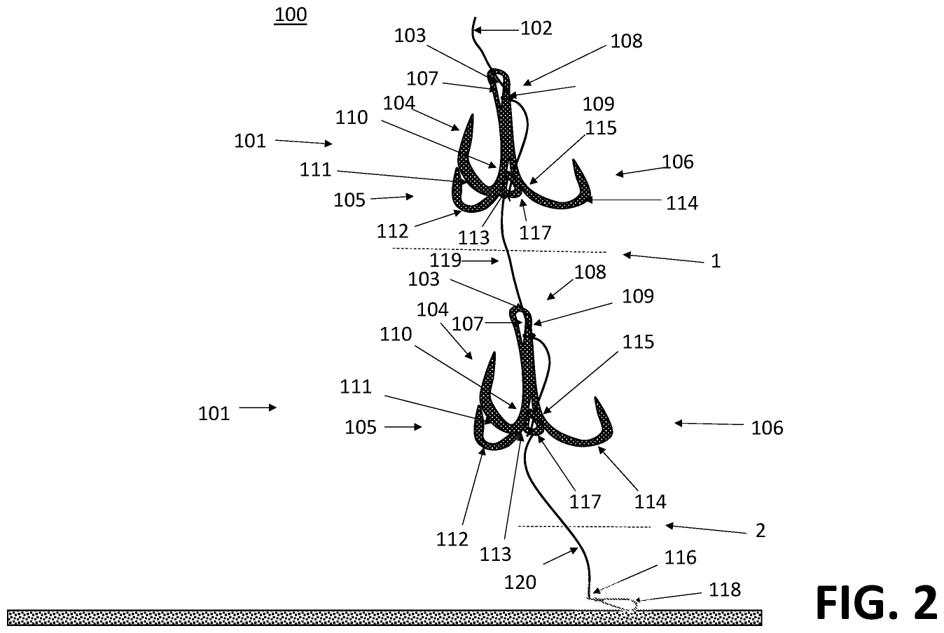

Moving now to FIG. 2, the second fish line 119 is coupled through a second fish line device 117. A third fish line 120 is coupled to the second eyelet 117 and is threaded through the second eyelet 117 where it may be tied. Optionally and/or additionally, an end 116 of the second fish line 120 is coupled to a weight 118. The second fish line 120 is lighter fish line than the fish line 101 and the second fish line 119, thus if the weight 118 is snagged and causes the line to break, the third fish line 120 will break at third breaking point 2 and the weight 118 will be lost but the hook 100 will not be broken from the fish line 101.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fish hook device for keeping the hook in a desired position, the device comprising:
a hook, the hook having a first prong hook, a second prong hook and a third prong hook;
a first eyelet, the first eyelet configured to be coupled to a top of the first prong hook, to a top of the second prong hook and to a top of the third prong hook;
a second eyelet, the second eyelet configured to be coupled to a top portion of the bent portion of the first prong hook, a top portion of the bent portion of the first prong hook, and a top portion of the bent portion of the first prong hook; and
wherein a fish line being configured to be threaded through the first eyelet and wherein the fish line being configured to be threaded through the second eyelet.

2. The device of claim 1, wherein the hook being made of a metal material.

3. The device of claim 2, wherein the material being steel.

4. The device of claim 1, wherein the hook being a treble prong hook.

5. The device of claim 1, wherein the hook being made of a single piece of material.

6. The device of claim 1, the device further comprising a weight.

7. The device of claim 6, wherein the weight being coupled to an end of the fish line.
